(19) United States
(12) Patent Application Publication
(10) Pub. No.: US 2016/0230861 A1
(43) Pub. Date: Aug. 11, 2016

(54) Linear Actuator Capable of Measuring Distance

(71) Applicant: Chia-Ming Cheng, Kaohsiung City (TW)

(72) Inventor: Chia-Ming Cheng, Kaohsiung City (TW)

(21) Appl. No.: 14/673,795

(22) Filed: Mar. 30, 2015

(30) Foreign Application Priority Data
Feb. 10, 2015 (TW) 104104325

(51) Int. Cl. F16H 25/20

(52) U.S. Cl. CPC F16H 25/2015

(57) ABSTRACT

A linear actuator includes an actuator including a housing, a power drive mounted at one end of the housing, a screw rod axially disposed in the housing, a connection member connected between the screw rod and the power drive, a sliding block threaded onto the screw rod, and a push rod affixed to the sliding block and extending out of the housing, and a resistance scale including a resistance substrate affixed to an inner wall of the housing at an inner bottom side and a electric brush affixed to a bottom side of the sliding block and kept in contact with the resistance substrate.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to linear actuators, and more particularly to a linear actuator capable of measuring distance that has the resistance scale mounted inside the actuator and kept from sight.

2. Description of Related Arts

Linear actuator has a wide range of applications in many industries. Resistance scale type linear actuator is most commonly used for precision machinery application. A resistance scale type linear actuator (or called as linear potentiometer feedback device) (as shown in FIG. 1) generally comprises an actuator 10 and a resistance scale 20. The actuator 10 (see FIG. 2 and FIG. 3) comprises a housing 101, a power drive 102, a connection member 103, a screw rod 104, a sliding block 105, a push rod 106, and an end cap 107. The housing 101 is a hollow aluminum extrusion shell. The power drive 102 is mounted at one end of the housing 101 (see FIG. 3). The connection member 103 is mounted inside the housing 101. The screw rod 104 is axially accommodated in the housing 101. The connection member 103 is connected between the power drive 102 and the screw rod 104. The sliding block 105 is threaded onto the screw rod 104. Further, the push rod 106 is fixedly connected to an outer wall of the sliding block 105 and extending out of the housing 101. The end cap 107 is capped on the opposite end of the housing 101. The resistance scale 20 comprises a casing 201, a resistance substrate 202 and an electric brush holder 203 mounted in the casing 201, an electric brush 2031 mounted in the electric brush holder 203 and kept in contact with the resistance substrate 202 for electric conduction, and a rod member 204 connected to one end of the electric brush holder 203 and extending out of the casing 201 and connected to the push rod 106 by a connector 30. Further, the actuator 10 and the resistance scale 20 are fastened together with two fastening members 40.

In application, the resistance scale 20 is electrically connected to a distance indicator (not shown). When the screw rod 104 is driven to rotate by the power drive 102, the sliding block 105 is axially moved in the housing 101 in direction toward the outside to extend out the push rod 106. At this time, the rod member 204 of the resistance scale 20 is moved outwards by the push rod 106, causing displacement of the electric brush 2031 on the resistance substrate 202. During movement of the electric brush 2031 on the resistance substrate 202, the resistance value is relatively changed to provide a corresponding voltage signal that is then converted into a digital signal and indicated in the distance indicator, achieving the expected measurement.

Because the aforesaid resistance scale type linear actuator is comprised of an actuator 10 and a resistance scale 20 that is exposed to the outside of the actuator 10, it occupies much installation space and has a heavy weight. Further, because this design of resistance scale type linear actuator consists of a large number of components, its manufacturing cost is high and, its installation requires much labor and time. Further, the components can loosen easily upon vibration, resulting in measurement inaccuracy.

### SUMMARY OF THE PRESENT INVENTION

The present invention has been accomplished under the circumstances in view. It is one object of the present invention to provide a linear actuator capable of measuring distance, which has the advantages of simple structure, small size, inexpensive manufacturing cost and high measurement precision.

To achieve this and other objects of the present invention, a linear actuator comprises an actuator and a resistance scale. The actuator comprises a housing, a power drive, a connection member, a screw rod, a sliding block and a push rod. The power drive is mounted at one end of the housing. The connection member and the screw rod are axially disposed in the housing. The connection member is connected between the power drive and the screw rod. The sliding block is threaded onto the screw rod. The push rod is affixed to one side of the sliding block, and extended out of the housing. The screw rod is rotatable by the power drive. The sliding block is axially moved in the housing along the screw rod to move the push rod in or out of the housing upon rotation of the screw rod in one of two reversed directions. The resistance scale comprises a resistance substrate and an electric brush. The resistance substrate is fixedly mounted at an inner wall of the housing. The electric brush is fixedly mounted at an outer wall of the sliding block, and kept in contact with the resistance substrate.

Preferably, the resistance substrate is located at an inner bottom side inside the housing; the electric brush is located at a bottom side of the sliding block.

Preferably, the housing comprises at least two peepholes for detecting the resistance value of the resistance substrate.

Preferably, the linear actuator further comprises an end cap capped on an opposite end of the housing around the push rod. The end cap comprises a tubular flange extended out of the housing. The push rod extends through the tubular flange of the end cap to the outside of the housing.

Because the resistance scale is formed in the inside of the actuator in integrity, it will not become loose easily. Further, because the push rod and the electric brush are synchronously movable in the same axial path, the linear actuator can significantly reduce the impact of shaking, enhancing the measurement precision.

### BRIEF DESCRIPTION OF THE DRAWINGS

FIG. 1 is an oblique top elevational view of a resistance scale type linear actuator according to the prior art.

FIG. 2 is an exploded view of the resistance scale type linear actuator according to the prior art.

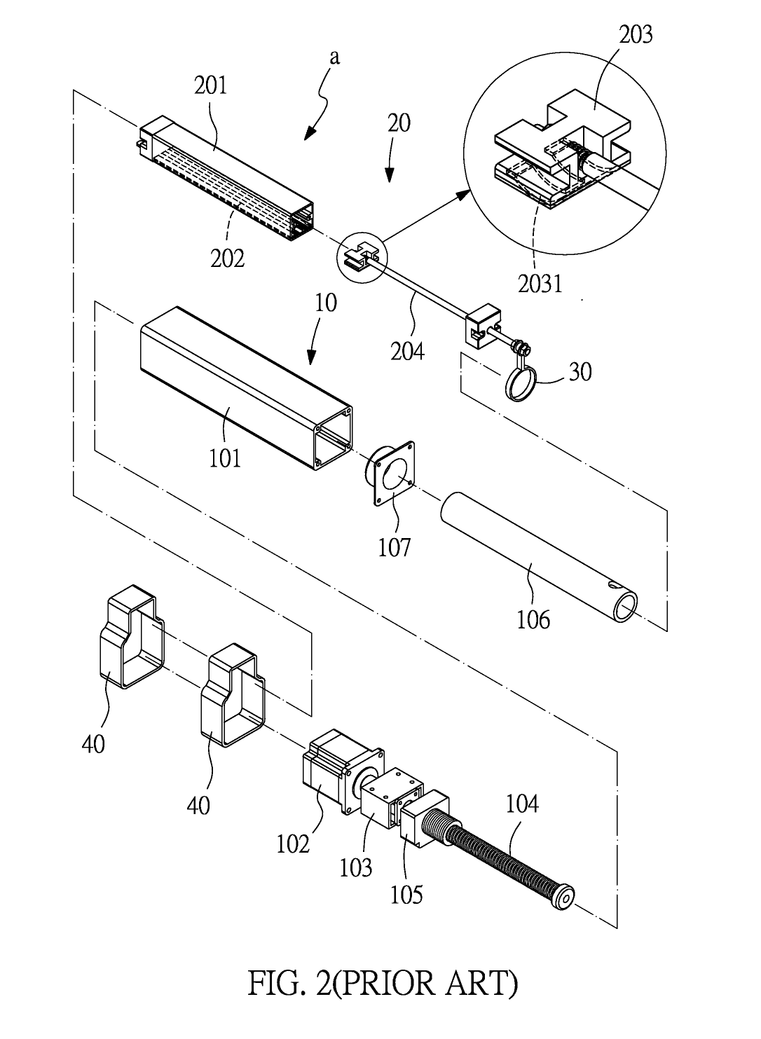

FIG. 3 is a sectional side view, in an enlarged scale, of the resistance scale type linear actuator shown in FIG. 1.

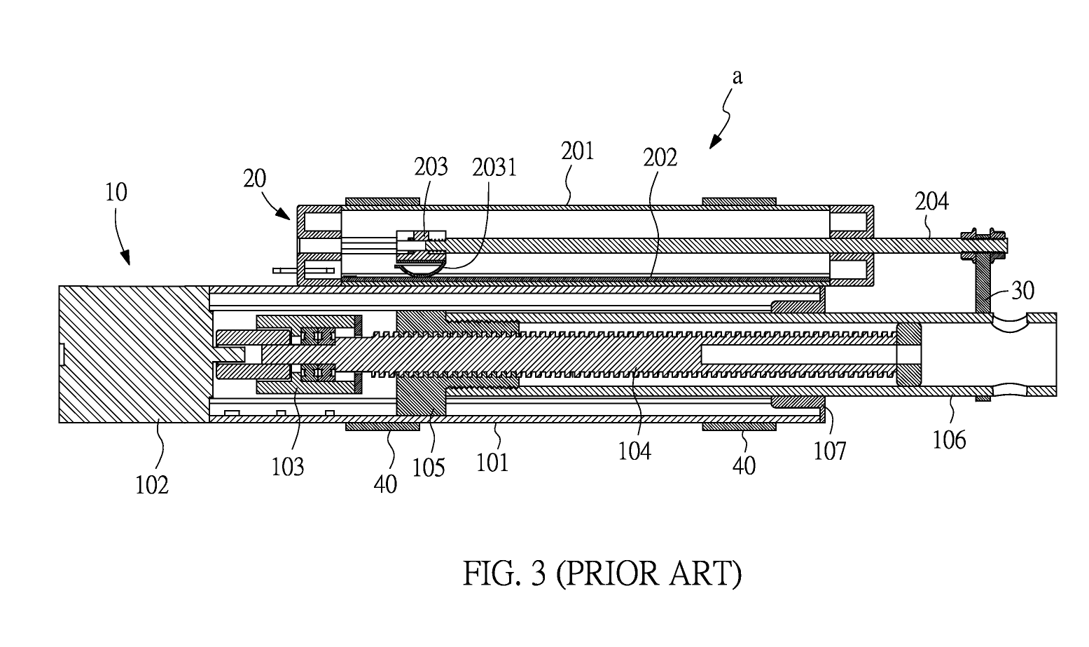

FIG. 4 is an elevational view illustrating an application status of a linear actuator in accordance with the present invention.

FIG. 5 is an exploded view of the linear actuator in accordance with the present invention.

FIG. 6 is a sectional side view of the linear actuator in accordance with the present invention.

FIG. 7 is a schematic operational view of the linear actuator in accordance with the present invention.

### DETAILED DESCRIPTION OF THE PREFERRED EMBODIMENT

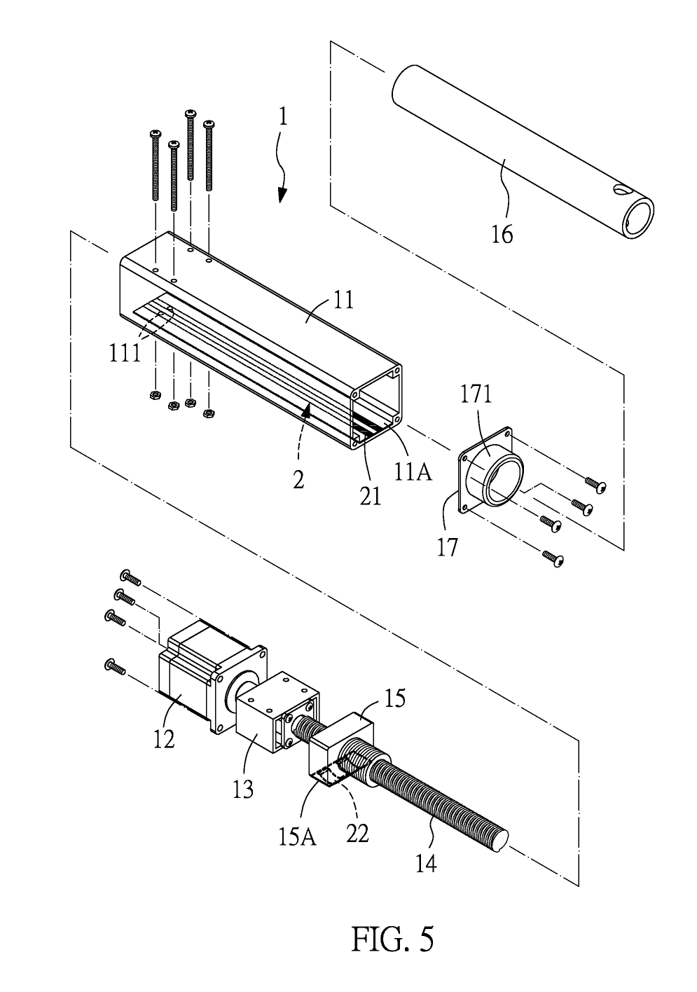

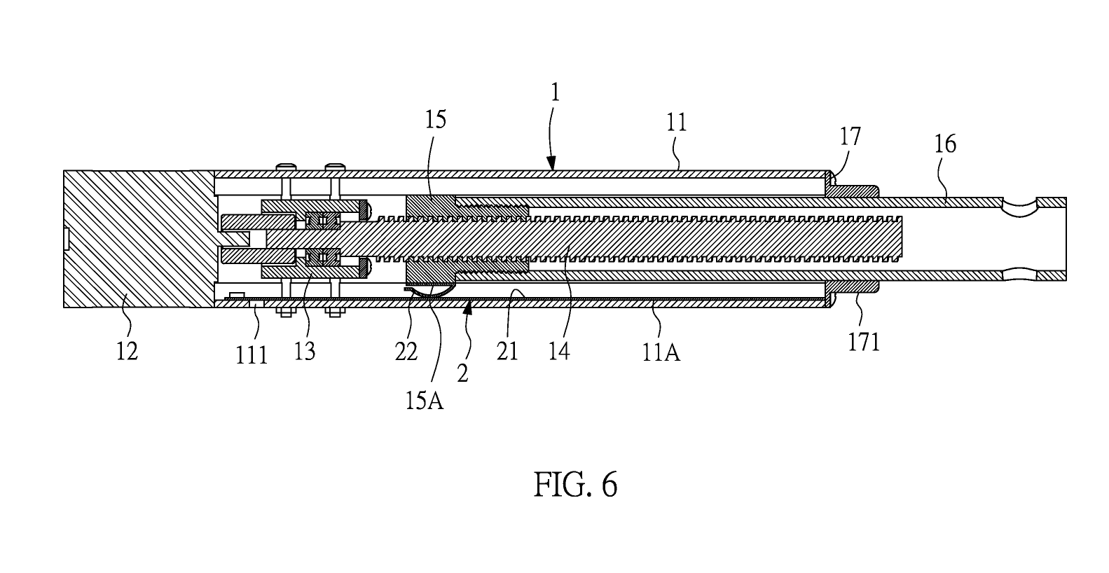

Referring to FIG. 5 and FIG. 6, a linear actuator in accordance with the present invention is shown. The linear actuator comprises an actuator 1 and a resistance scale 2.

The actuator 1 (as shown in FIG. 5 and FIG. 6) comprises a housing 11, a power drive 12, a connection member 13, a screw rod 14, a sliding block 15 and a push rod 16. The housing 11 is a hollow aluminum extrusion shell. The power drive 12 is mounted at one end, namely, the rear end of the housing 11. The connection member 13 is accommodated in the housing 11 near the rear end. The screw rod 14 is axially movably accommodated in the housing 11 in such a manner that the connection member 13 is connected between the power drive 12 and the screw rod 14. In actual application, the other end of the screw rod 14 can be disposed inside the housing 11, or partially extended out of the housing 11. The sliding block 15 is movably disposed in the housing 11 and threaded onto the screw rod 14. The push rod 16 has its one end affixed to the sliding block 15, and its opposite end extending out of the housing 11. Further, an end cap 17 is capped on an opposite end, namely, the front end of the housing 11. The end cap 17 comprises a tubular flange 171 suspending outside the housing 11. The push rod 16 is movably extended through the tubular flange 171 to the outside of the housing 11.

The resistance scale 2 (see FIG. 5 and FIG. 6) comprises a resistance substrate 21 and an electric brush 22. The resistance substrate 21 is affixed to an inner wall 11 A of the housing 11 (located at an inner bottom side inside the housing as shown in FIG. 6). The electric brush 22 is affixed to an outer wall 15 A of the sliding block 15 (located at the bottom side of the sliding block as shown in FIG. 6) and kept in contact with the resistance substrate 21.

Further, the housing 11 comprises two peepholes 111 for detecting the resistance value of the resistance substrate 21.

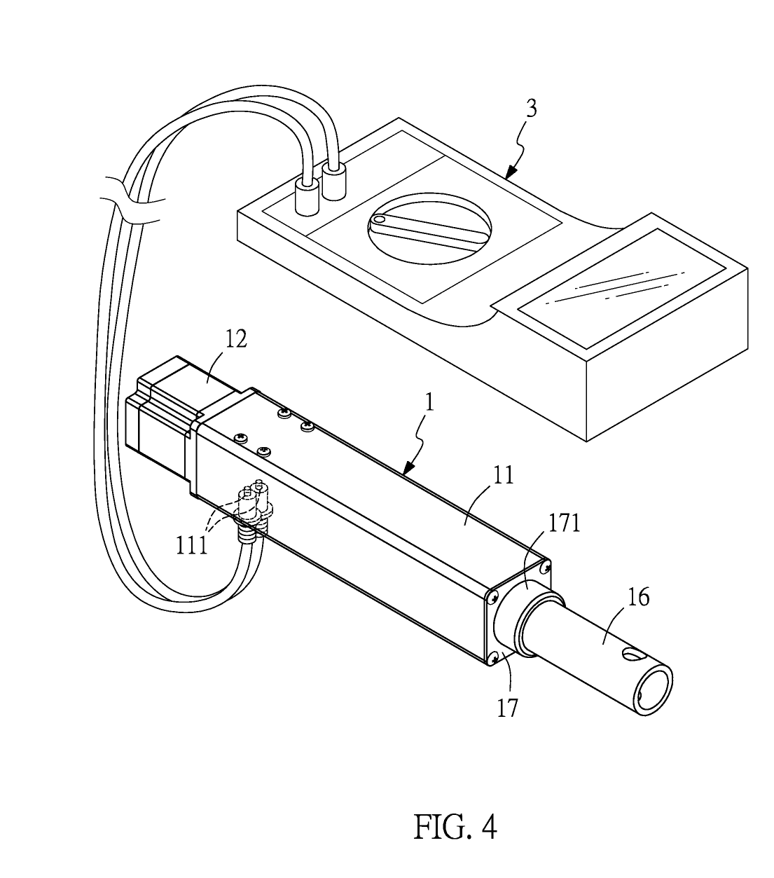

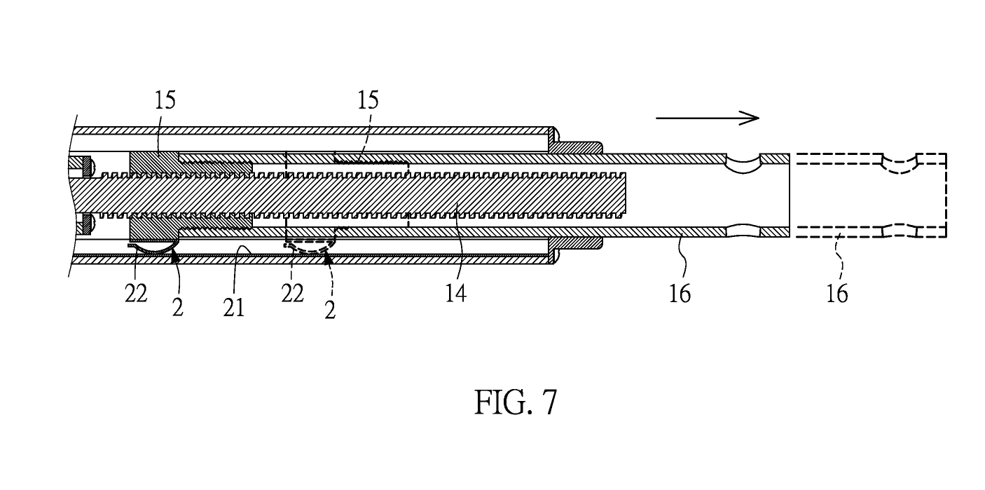

In application, the resistance scale 2 is electrically connected to a distance indicator 3 (for example, resistance meter, as shown in FIG. 4). In measurement, start up the power drive 12 to rotate the screw rod 14, moving the push rod 16 outwardly to the measuring point. At the same time, the sliding block 15 is moved axially in the housing 11 toward the outside. At this time, the electric brush 22 is moved with the sliding block 15 along the top surface of the resistance substrate 21 (see FIG. 7), causing a change in the resistance value and producing a voltage signal output that is then converted into a digital signal and indicated in the distance indicator 3, thereby achieving the expected measurement.

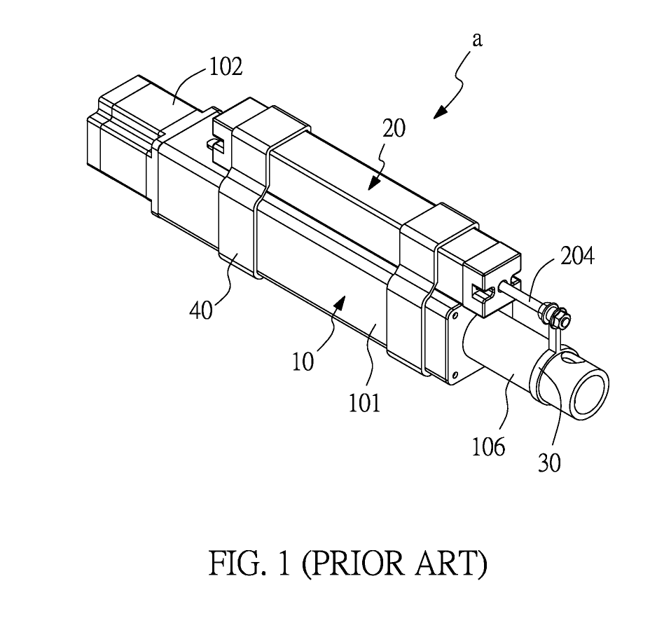

When compared to the prior art design as indicated in FIG. 1 and FIG. 4, the linear actuator of the invention has the advantages of simple structure and small size, saving much installation labor and time, and thus, the cost of the linear actuator can be significantly lowered. More particularly, because the resistance scale 2 is formed in the inside of the actuator 1 in integrity, it will not become loose easily. Further, because the push rod 16 and the electric brush 22 are synchronously movable in the same axial path, the linear actuator can significantly reduce the impact of shaking, enhancing the measurement precision.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A linear actuator comprising an actuator and a resistance scale, said actuator comprising a housing, a power drive, a connection member, a screw rod, a sliding block and a push rod, said power drive being mounted at one end of said housing, said connection member and said screw rod being axially disposed in said housing, said connection member being connected between said power drive and said screw rod, said sliding block being threaded onto said screw rod, said push rod being affixed to one side of said sliding block and extended out of said housing, said screw rod being rotatable by said power drive, said sliding block being axially moved in said housing along said screw rod to move said push rod in or out of said housing upon rotation of said screw rod in one of two reversed directions, said resistance scale comprising a resistance substrate and a electric brush, wherein said resistance substrate is fixedly mounted at an inner wall of said housing; said electric brush is fixedly mounted at an outer wall of said sliding block and kept in contact with said resistance substrate.

2. The linear actuator as claimed in claim 1, wherein said resistance substrate is located at an inner bottom side inside said housing; said electric brush is located at a bottom side of said sliding block.

3. The linear actuator as claimed in claim 1, wherein said housing comprises at least two peepholes for detecting the resistance value of said resistance substrate.

4. The linear actuator as claimed in claim 3, further comprising an end cap capped on an opposite end of said housing around said push rod, said end cap comprising a tubular flange extended out of said housing; said push rod extends through said tubular flange of said end cap to the outside of said housing.
